(19) United States
(12) Patent Application Publication
(10) Pub. No.: US 2015/0009664 A1
(43) Pub. Date: Jan. 8, 2015

(54) LED Tube

(71) Applicant: PHIHONG TECHNOLOGY CO., LTD., Taoyuan County (TW)

(72) Inventor: Chien-Hua Liang, Taoyuan County (TW)

(73) Assignee: PHIHONG TECHNOLOGY CO., LTD., Taoyuan County (TW)

(21) Appl. No.: 14/103,700

(22) Filed: Dec. 11, 2013

(30) Foreign Application Priority Data
Jul. 2, 2013 (TW) 102123677

(51) Int. Cl. F21K 99/00

(52) U.S. Cl. CPC F21K 9/17
USPC 362/219; 362/221

(57) ABSTRACT

An LED tube including a tube body, a male connecting set, a female connecting set and an LED circuit board is provided, wherein the tube body has two respective terminals, the male connecting set and the female connecting set are disposed on the terminals of the tube body respectively, and the LED circuit board is disposed on the tube body. The male connecting set includes a first direction male connector and a second direction male connector, and the female connecting set includes a first direction female connector corresponding to the first direction male connector, and a second direction female connector corresponding to the second direction male connector.

### TECHNICAL FIELD

Embodiments of the invention generally relate to the field of LED tubes and, more particularly, to LED tubes which can be connected in tandem.

### BACKGROUND

Light-Emitting Diodes (LEDs) have the advantages of high luminance, low power consumption, and being eco-friendly. They have already been extensively applied in many kinds of lighting equipment for the past few years. Moreover, fluorescent lamps are increasingly replaced by LED tubes with LEDs as the light source and such LED tubes have gradually become the mainstream of domestic lighting.

LED tubes generate visible light by the combination of electron-hole pairs through an over-voltage. Therefore a plurality of LED tubes can be assembled in tandem to form LED tube tandems in varying length for differing demands.

Taiwan Patent Application Publication No. M260698 regards LED tubes using extra wires for the connection in tandem, which is rather difficult to use and results in increasing costs.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a perspective view of the LED tube based upon an embodiment of the present invention.

FIG. 2 is a partially enlarged view of the LED tube in FIG. 1.

FIG. 3 is a schematic partial view before two LED tubes in FIG. 1 are connected.

FIG. 4 is a schematic partial view after two LED tubes in FIG. 3 are connected.

FIG. 5 is a side view of the LED tube.

### SUMMARY

In view of this, the purpose of the present invention is to provide an LED tube, which can be directly connected in tandem and then put to use based upon user demands.

To achieve the above-mentioned or other purposes, a LED tube which comprises a tube body, a male connecting set, a female connecting set, and a LED circuit board is proposed in the present invention. Wherein the tube body has two respective terminals; the male connecting set and the female connecting set are deployed on the terminals of the tube body respectively; and the LED circuit board is deployed on the tube body. The male connecting set includes a first direction male connector and a second direction male connector, while the female connecting set includes a first direction female connector and a second direction female connector, wherein the first direction female connector corresponds to the first direction male connector, and the second direction female connector corresponds to the second direction male connector.

In one embodiment, the materials of the tube body, the male connecting set, and the female connecting set are plastics of high thermal conductivity.

In one embodiment, the first direction male connector is for example a T-type buckle; the first direction female connector is for example a T-type slot; the second direction male connector is for example a positioning protrusion; the second direction female connector is for example a positioning recess.

To sum up, in the LED tube of the present invention, the male connecting set of any LED tube is connected to the female connecting set of other LED tube, while a LED tube tandem is formed by connecting these two LED tubes in tandem. By means of the male connecting set and the female connecting set of a LED tube, no extra wire or other accessory is required for the present invention which facilitates the assembly of the LED tube tandem into any required length, reduces the cost, and makes the assembling more convenient at the same time.

### DETAILED DESCRIPTION

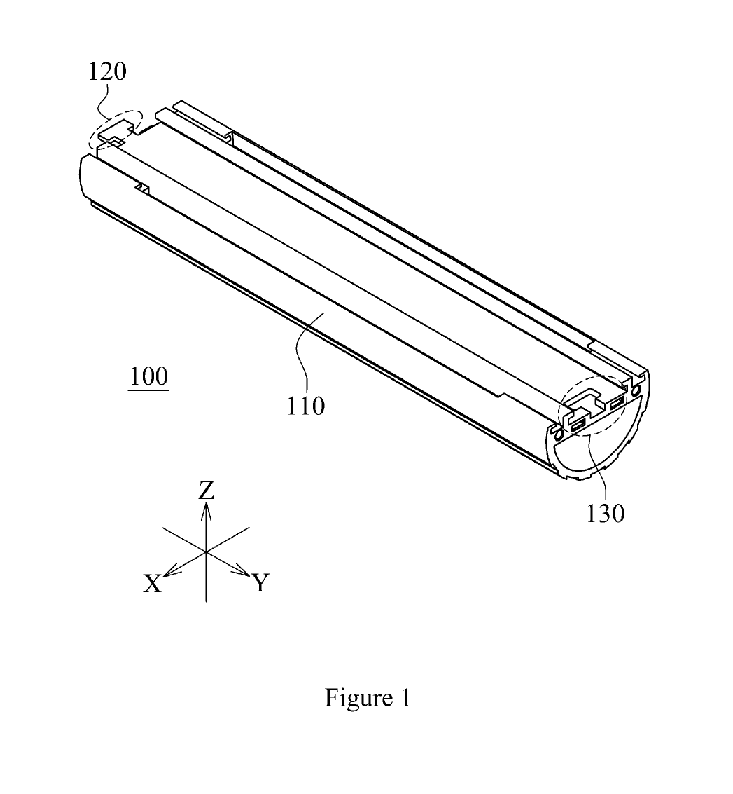

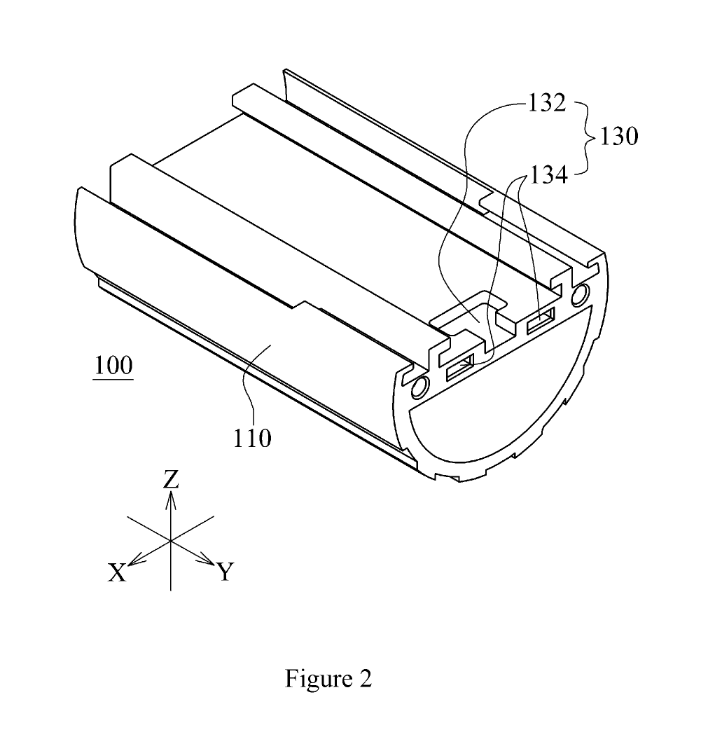

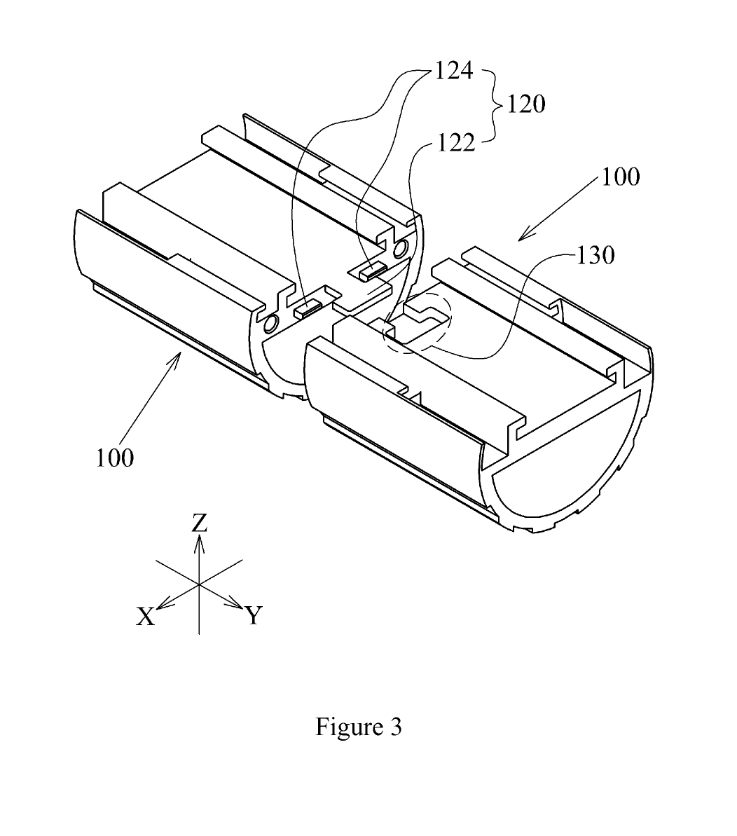

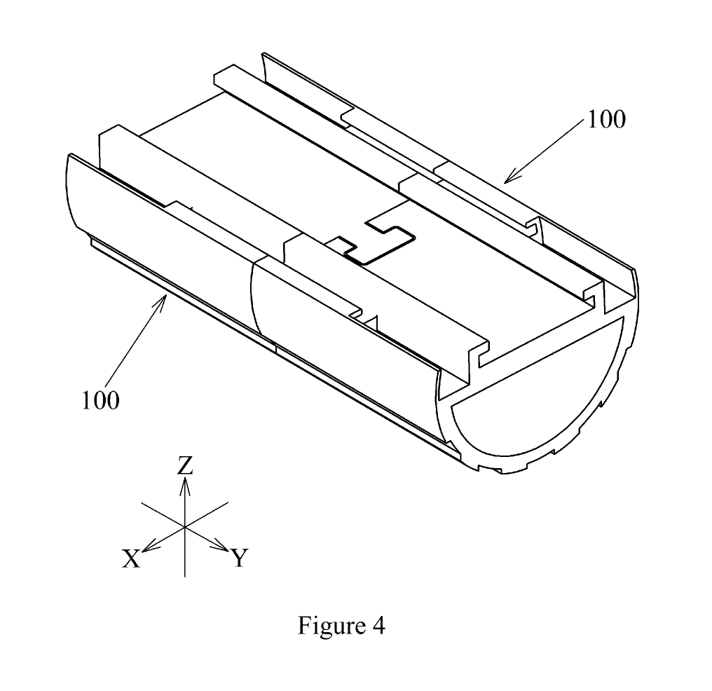

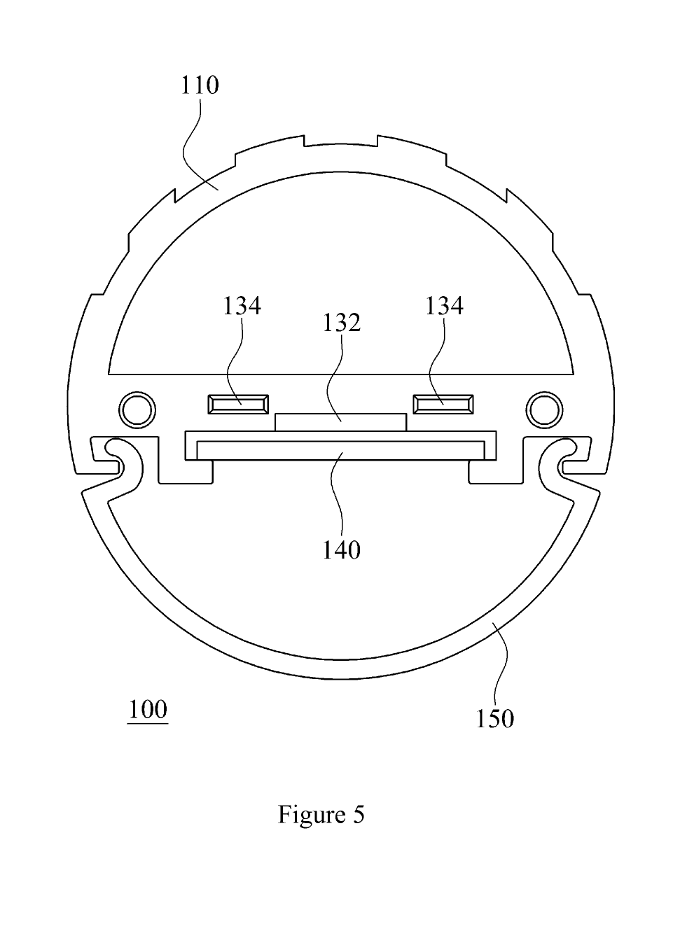

FIG. 1 is a perspective view of the LED tube based upon an embodiment of the present invention; FIG. 2 is a partially enlarged view of the LED tube in FIG. 1; FIG. 3 is a schematic partial view before two LED tubes in FIG. 1 are connected; FIG. 4 is a schematic partial view after two LED tubes in FIG. 3 are connected; FIG. 5 is a side view of the LED tube.

Referring to FIG. 1-5 simultaneously, the LED tube 100 of the present invention includes a tube body 110, a male connecting set 120, a female connecting set 130, and a LED circuit board 140, wherein the tube body 110 is provided with two respective terminals, while the male connecting set 120 and the female connecting set 130 are placed at the opposite ends of the tube body 110, and the LED circuit board 140 is placed on the tube body 110.

It is worth noting that, the male connecting set 120 of any LED tube 100 of this embodiment is connected with the female connecting set 130 of another LED tube 100. But for the sake of easy depiction, there are occasionally descriptions of ways of connecting a male connecting set 120 with a female connecting set 130 and the detailed components. It should be appreciated by those skilled in the art that the male connecting set 120 and female connecting set 130 being connected belong to two different LED tubes 100, which will not be stated repeatedly hereafter.

In addition, for the sake of clear illustration of the detailed structure of the male connecting set 120 and the female connecting set 130, the LED circuit board 140 is omitted in FIG. 1-4, it should be appreciated by those skilled in the art based on the position of the LED circuit board 140 in FIG. 5.

Referring further to FIG. 1-5, when the corresponding male connecting set 120 and female connecting set 130 are connected, the two LED tubes 100 can form a LED tube tandem. For a better and secure connection, the male connecting set 120 includes a first direction male connector 122 and a second direction male connector 124, while the female connecting set 130 includes a corresponding first direction female connector 132 and a second direction female connector 134.

For the pressure applied on the LED tube 100 in the Z direction, upon the completion of the connection of the first direction male connector 122 and the first direction female connector 132, the structure can effectively resist the pressure to avoid the LED tube 100 from expanding. For the pressure applied on the LED tube 100 in the X direction, upon the completion of the connection of the second direction male connector 124 and the second direction female connector 134, the structure can effectively resist the pressure to avoid the LED tube 100 from contracting.

In this embodiment, the first direction male connector 122 may be a T-type buckle, and the first direction female connector 132 may be a corresponding T-type slot. The second direction male connector 124 may be a positioning protrusion, and the second direction female connector 134 may be a corresponding positioning recess. In more detail, the number of T-type buckle is one, and the number of positioning protrusions is two, which are placed respectively at the two ends of the T-type buckle in the X direction. However, the present invention is not limited to any specific number of first direction male connector 122, first direction female connector 132, second direction male connector 124, and second direction female connector 134.

As for the way to connect, firstly a LED tube 100 should be positioned at an angle of 15 degrees relative to another LED tube 100 (which is not illustrated here). And then the second direction male connector 124 (positioning protrusion) can be inserted half way into the second direction female connector 134 (positioning recess) for positioning. Then by raising another LED tube 100 accordingly, the first direction male connector 122 (T-type buckle) can be buckled into the first direction female connector 132 (T-type slot) and the connection of LED tubes 100 is completed.

Upon completion of connection, the combination of T-type buckle and T-type slot can effectively resist the deformation due to the pressure in the Z direction, and the combination of positioning protrusion and positioning recess can effectively resist the deformation due to the pressure in the X direction. For the LED tubes 100 connected in tandem, the present invention refrains a long tandem from any detachment or large deformation which may affect the operation of internal electronic components.

Even though this embodiment is illustrated by T-type buckles and T-type slots, and positioning protrusions and positioning recesses, the present invention is not limited to any specific form of the first direction male connector 122, first direction female connector 132, second direction male connector 124, and second direction female connector 134. For example, a hook, a latch, a clamp or other applicable shape of buckles or slots are all applicable connectors for the present invention.

Moreover, any LED tube 100 of the present invention can be viewed as a unit module of the assembly, and its length is for example 90 mm. By assembling a varying number of these standard LED tubes 100, a LED tube tandem in a particular length can be formed to meet market demands. For example, by using two, four, or eight pieces of LED tubes 100 in this embodiment, LED tube tandems measuring 180 mm, 360 mm, and 720 mm in length are formed respectively. However, the present invention is neither limited to any specific number of LED tubes 100 for assembly, nor limited to any specific unit length of the LED tube 100.

Referring further to FIG. 1-5, the materials of tube body 110, male connecting set 120 and female connecting set 130 of this embodiment may be plastics of high thermal conductivity and a structure integrally formed by injection molding to facilitate the conduction of the resulting waste heat of LED to the outside. However, the present invention is not limited to any specific structure or way of formation. For example, the materials of tube body 110, male connecting set 120 and female connecting set 130 may be metal as well, which may be assembled by welding.

In addition, the shape of the tube body 110 is for example tube-shaped. And further in FIG. 5, the LED tube 100 of this embodiment may even include a lampshade 150 corresponding to the tube body 110. However, the tube body 110 and the lampshade 150 may have different shapes against varying demands or cosmetic reasons.

To sum up, the LED tube of this invention has at least the following advantages:

1. A LED tube tandem in the required length can be easily assembled without requiring any extra wire or other accessory; this not only reduces the cost, but also makes the assembling more convenient at the same time.

2. The combination of T-type buckle and T-type slot and the combination of positioning protrusion and positioning recess can effectively resist the deformation due to the pressure in the radial direction, this refrains the LED tubes being connected from any large deformation which affects the operation of internal electronic components.

While the invention has been disclosed above as the preferred embodiment, it is not provided to limit the invention. For those skilled in the art, some modifications and adaptations may be made without departing from the spirit and scope of the invention. Therefore, the scope of invention protection depends on those defined by the claims.

What is claimed is:

1. An LED tube comprising:
a tube body including two respective terminals;
a male connecting set placed at one end of the tube body, wherein the male connecting set comprises a first direction male connector and a second direction male connector;
a female connecting set placed at other end of the tube body, wherein the female connecting set comprises a first direction female connector and a second direction female connector, wherein the first direction female connector corresponds to the first direction male connector, and the second direction female connector corresponds to the second direction male connector; and
an LED circuit board placed on the tube body.

2. The LED tube of claim 1, wherein materials of the tube body, the male connecting set, and the female connecting set are plastics of high thermal conductivity.

3. The LED tube of claim 2, wherein the first direction male connector is a T-type buckle, the first direction female connector is a T-type buckle slot, the second direction male connector is a positioning protrusion, and the second direction female connector is a positioning recess.

4. A tandem of LED tubes comprising:
a plurality of LED tubes of claim 2, wherein the male connecting set of any LED tube is connected to the female connecting set of another LED tube.

5. The tandem of LED tubes of claim 4, wherein the length of the LED tubes is the same.

6. The tandem of LED tubes of claim 4, wherein the length of the LED tubes is 90 mm.

7. The tandem of LED tubes of claim 4, wherein the number of LED tubes is two, four or eight.
